(19) United States
(12) Patent Application Publication
(10) Pub. No.: US 2006/0149784 A1
(43) Pub. Date: Jul. 6, 2006

(54) System and method for operating modules of a claims adjudication engine

(76) Inventors: Rob Tholl, Calgary (CA); Clayton Russell, Calgary (CA)

Correspondence Address: Gowling Lafleur Henderson LLP, Suite 4900, Commerce Court West, Toronto, M5L 1J3, CA

(21) Appl. No.: 11/025,912

(22) Filed: Jan. 3, 2005

(51) Int. Cl. G06Q 40/00; G06F 17/00

(52) U.S. Cl. 707/104.1; 705/4

(57) ABSTRACT

A system and method for configuring an adjudication system to adjudicate a claim transaction. The system and method comprise: receiving the claim transaction containing line items describing an insured service for a recipient to be financed by a payer for the insured service; providing an adjudication engine for coordinating the adjudication processing of the received claim transaction; representing the claim transaction as a plurality of business objects coupled to a database such that the business objects are selected from a set of available business objects, the business objects coupled to the adjudication engine and configured for containing data instances of the claim transaction; and selecting a plurality of adjudication modules for coupling to the plurality of business objects, the plurality of adjudication modules selected from a set of available adjudication modules, the selected adjudication modules configured for providing business logic applied to the business objects during the adjudication processing to manipulate the data instances of the business objects; wherein the configured adjudication system adjudicates the data instances of the business objects according to the business logic of the selected adjudication modules for determining an adjudication status of the claim transaction.

### BACKGROUND OF THE INVENTION

It is recognised in the health care industry that in order to service patient population, health care providers, by necessity, have become participants in many networks. This requires the complex management of many fee schedules, a process that is commonly outside of the capabilities of most practice management systems. The process is then left up to the payer, or each of the networks, creating further delays and added costs to health plans. Further, it is recognised that there are many industry efforts in place to reduce cost, as well as constant Federal and State legislative changes, and electronic transaction code sets, and privacy and security requirements. Therefore, health claims processing has become a costly and time consuming endeavour in the current health care industry.

For example, the current healthcare claims system is the source where inefficiencies contribute in administrative overhead and delays. Furthermore, providers are suffering from bad debt expenses on patient payment amounts. In addition the current medical claims system is fraught with the high potential for errors and omissions resulting in more cost to process claims. Providers realise that the reduction of their Account Receivables balance and reconciliation time is desirable. This reduction can happen through more direct eligibility verification, streamlined management of many network relationships, and faster payment. For payers, a key to more efficient plan management is increasing their membership. This membership increase can happen through a value proposition which includes increasing auto-adjudication rates by reducing rejected claims and eliminating many of the steps required in order to accomplish today's claims administration. There is a need for the implementation of a rules based adjudication engine flexible enough to implement new plans/benefits and associated adjudication modules more rapidly and at lower costs than current static adjudication systems.

It is an object of the present invention to provide a claims processing system to obviate or mitigate some of the above-presented disadvantages.

### SUMMARY OF THE INVENTION

Providers are suffering from bad debt expenses on patient payment amounts. In addition the current medical claims system is fraught with the high potential for errors and omissions resulting in more cost to process claims. Providers realise that the reduction of their Account Receivables balance and reconciliation time is desirable. This reduction can happen through more direct eligibility verification, streamlined management of many network relationships, and faster payment. For payers, a key to more efficient plan management is increasing their membership. This membership increase can happen through a value proposition which includes increasing auto-adjudication rates by reducing rejected claims and eliminating many of the steps required in order to accomplish today's claims administration. There is a need for the implementation of a rules based adjudication engine flexible enough to implement new plans/benefits and associated adjudication modules more rapidly and at lower costs than current static adjudication systems. Contrary to current adjudication systems, there is provided a system and method for configuring an adjudication system to adjudicate a claim transaction. The system and method comprise: receiving the claim transaction containing line items describing an insured service for a recipient to be financed by a payer for the insured service; providing an adjudication engine for coordinating the adjudication processing of the received claim transaction; representing the claim transaction as a plurality of business objects coupled to a database such that the business objects are selected from a set of available business objects, the business objects coupled to the adjudication engine and configured for containing data instances of the claim transaction; and selecting a plurality of adjudication modules for coupling to the plurality of business objects, the plurality of adjudication modules selected from a set of available adjudication modules, the selected adjudication modules configured for providing business logic applied to the business objects during the adjudication processing to manipulate the data instances of the business objects; wherein the configured adjudication system adjudicates the data instances of the business objects according to the business logic of the selected adjudication modules for determining an adjudication status of the claim transaction.

According to the present invention there is provided a method for configuring an adjudication system to adjudicate a claim transaction, the method comprising the steps of: receiving the claim transaction containing at least one line item describing an insured service for a recipient to be financed by a payer for the insured service; providing an adjudication engine for coordinating the adjudication processing of the received claim transaction; representing the claim transaction as a plurality of data containers coupled to a database such that the data containers are selected from a set of available data containers, the data containers coupled to the adjudication engine and configured for containing data instances of the claim transaction; and selecting a plurality of adjudication modules for coupling to the plurality of data containers, the plurality of adjudication modules selected from a set of available adjudication modules, the selected adjudication modules configured for providing business logic for application to the data containers during the adjudication processing to manipulate the data instances of the data containers; wherein the configured adjudication system adjudicates the data instances of the data containers according to the business logic of the selected adjudication modules for determining an adjudication status of the claim transaction.

According to a further aspect of the present invention there is provided a system for configuring an adjudication system to adjudicate a claim transaction, the system comprising: an adjudication system for receiving the claim transaction containing at least one line item describing an insured service for a recipient to be financed by a payer for the insured service; an adjudication engine of the adjudication system for coordinating the adjudication processing of the received claim transaction; a plurality of data containers coupled to a database for representing the claim transaction such that the data containers are selectable from a set of available data containers, the data containers coupled to the adjudication engine and configured for containing data instances of the claim transaction; and a plurality of adjudication modules for coupling to the plurality of data containers, the plurality of adjudication modules selectable from a set of available adjudication modules, the adjudication modules configured for providing business logic for application to the data containers during the adjudication processing to manipulate the data instances of the data containers; wherein the configured adjudication system adjudicates the data instances of the data containers according to the business logic of the selected adjudication modules for determining an adjudication status of the claim transaction.

According to a still further aspect of the present invention there is provided a computer program product for configuring an adjudication system to adjudicate a claim transaction, the computer program product comprising: a computer readable medium; an adjudication system module stored on the computer readable medium for receiving the claim transaction containing at least one line item describing an insured service for a recipient to be financed by a payer for the insured service; an adjudication engine module coupled to the adjudication system module for coordinating the adjudication processing of the received claim transaction; a data container module coupled to the adjudication system module for providing a plurality of data containers coupled to a database for representing the claim transaction such that the data containers are selectable from a set of available data containers, the data containers coupled to the adjudication engine module and configured for containing data instances of the claim transaction; and a plurality of adjudication modules for coupling to the plurality of data containers, the plurality of adjudication modules selectable from a set of available adjudication modules, the adjudication modules configured for providing business logic for application to the data containers during the adjudication processing to manipulate the data instances of the data containers; wherein the configured adjudication system module adjudicates the data instances of the data containers according to the business logic of the selected adjudication modules for determining an adjudication status of the claim transaction.

### BRIEF DESCRIPTION OF THE DRAWINGS

These and other features will become more apparent in the following detailed description in which reference is made to the appended drawings wherein:

FIG. 1 is a block diagram of a claims management system;

FIG. 2 shows the adjudication system of FIG. 1;

FIG. 3 shows further detail of the adjudication system of FIG. 2;

FIG. 4 is a block diagram of a server of the adjudication system of FIG. 1;

FIG. 5 shows further examples of the hierarchies of FIG. 2; and

FIG. 6 an example operation of the adjudication system of FIG. 1.

### DETAILED DESCRIPTION OF THE PREFERRED EMBODIMENTS

Claim Management System 10

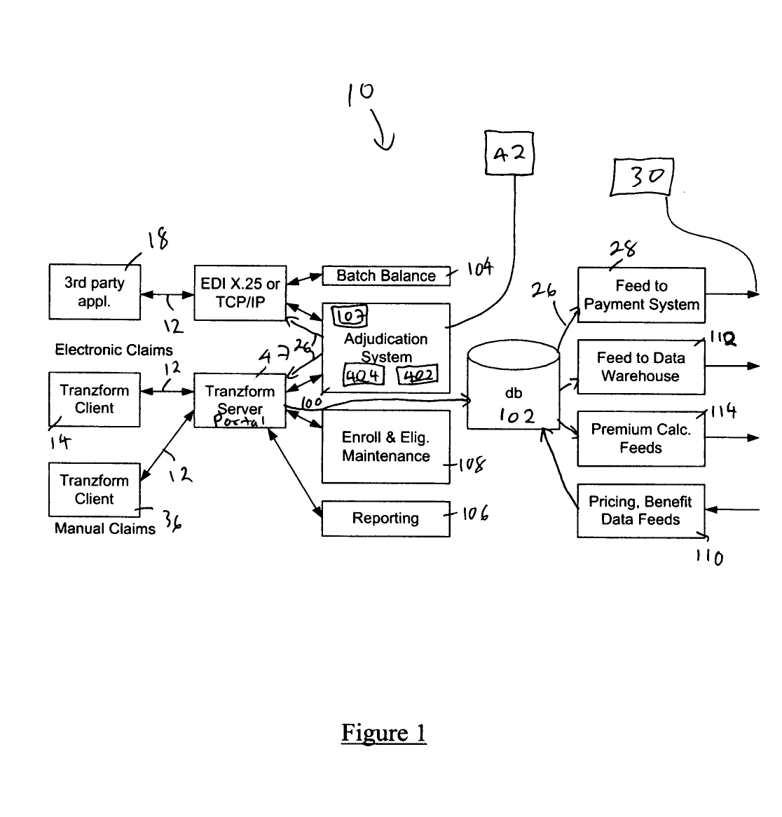

Referring to FIG. 1, a claims management system 10 processes electronically submitted claim data as claim transactions 12 sent by a provider 14 of insured services, such as but not limited to health, dental, vision, and drug. The provider 14 is a user of the system 10, can give insured services to a patient 36 (i.e. recipient), and can initiate the claim data transactions 12 through their submission to an adjudication system 100, via a claims submission portal 47. The submission portal 47 provides access to the adjudication system 100 and a database 102, as further described below. The patient 36 is a user of the system 10 who has benefits with a payer 30 of the insured services and can receive treatment (i.e. insured services) from the provider 14. The payer 30 is a user of the system 10, and can be an insurance company supporting the delivery of the insured services to the patient 36. Further, other third party applications 18 can submit electronic claim transactions 12 to the adjudication system 100 using claim submission protocols such as but not limited to EDI X.25 or TCP/IP in either real time and/or batch balancing 104. It is also recognised that the portal 47 can provide application screens for entering manual claims. This manual claim entry can be done either by staff at the insurer (payer 30) or by the recipient 36 or subscriber/company staff of the provider 14 directly. These entry screens can allow the entry of the expected claim data for the claim transactions 12, can generate the claim transaction 12 as an XML (or other structured definition language) document and send it to the adjudication system 100, can receive a response (e.g. XML) from the system 100 and display the response; and can adjust overrides, if desired, and repeat until the desired result is achieved. It is noted that the override ability can be restricted based upon the role assigned to the user of the portal 47 screens, e.g. so an insurer's clerical staff can override more than external staff are allowed to.

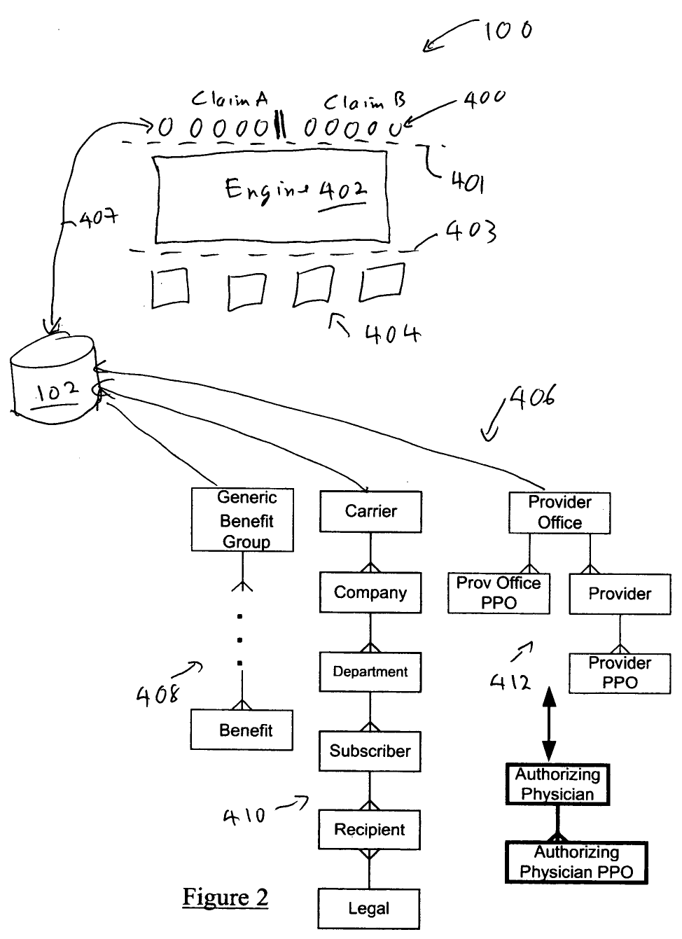

The portal 47 of the system 10 supports claim transactions 12 of insured services such as but not limited to medical, paramedical, dental, vision, and hospital claim transactions 12. The portal 47 has sign-on functionality to support a plurality of providers 14, whereby the providers 14 can interact with the system 10 by such as but not limited, submitting claim transactions 12, submitting voids, receiving functional acknowledgements of the transaction 12 processing, receiving remittance advice, conducting claim inquiries (e.g. to view previously submitted claim transactions 12), and conducting payment reconciliation inquiries. Other functionality provided by the portal 47 can include enrolment and eligibility maintenance 108 of insurance plans dictated by the payers 30, as well as report generation 106 (e.g. EOBs, etc.). It is recognised that the payers 30 can also access (not shown) the portal 47, or any other portal (not shown) providing payer access to the system 10, for example, to supply pricing and benefit data feeds 110 to the database 102 for use by the adjudication system 100. The screens and queues of the portal 47 can provide information about pending claim transaction 12 processing. Further, when the claim transaction 12 is being adjudicated and requires human intervention, the claim transaction 12 is marked as pending status and submitted to a workflow queue of the adjudication engine 402 (see FIG. 2) of the system 100 for later examination by a human. Processing examples requiring human intervention can include examples such as but not limited to an expected record in the database is missing, the amount asked for exceeds a configurable limit, the benefit type is flagged for human processing, or others.

The enrolment and eligibility maintenance module 108 can provide maintenance screens displayed on the portal 47, or other portal is desired. These maintenance screens are used to maintain the information needed for the adjudication system 100, such as company and department and other business object maintenance. Some of these maintenance screens, such as recipient and subscriber enrollment, may be accessible to the insurer's and the company's staff (e.g. payer 30). Other maintenance screens, such as those maintaining the workflow queues of the adjudication engine 402, may only be accessible to the payer's 30 staff. Note that the adjudication system 100 may be coupled to an external master data source for certain data (such as an external provider registry), in which case the maintenance screens for that data would not be required. As well, data may be regularly imported to the adjudication system 100 and associated database 102 from an external source (not shown), such as First Data Bank for drug information.

The report generation module 106 of the system 10 provides a reporting system. This reporting can also be a feed to a separate data warehouse 112 that is used for the majority of the reporting purposes. The reporting system of the report generation module 106 can be based on XSL, allowing the reuse of large portions of the existing XML infrastructure relating to retrieving claim and other information from the database 102. Further, the reporting system can easily produce reports in other formats such as but not limited to HTML, PDF, excel, and word formats.

Referring again to FIG. 1, the adjudication system 100 adjudicates the claim transaction 12 as a processed claim 26 having one of two submission states, either accepted or rejected. The claim transaction 12 can have one of the following adjudication states, complete, declined, voided, or pended. An adjudication engine 402 of the system 100 is a rules based engine that facilitates the processing of the claim transactions 12 (in conjunction with adjudication modules 404—see FIG. 2), voids in real/batch time, as well as can supply files of synchronous/asynchronous (i.e. real vs. batch) adjudication results for inclusion into the database 102. For example, asynchronous or non-real time claim results can be avoided by informing the provider 14 the claim data of the transaction 12 has been placed in pending status (with a corresponding claim number) via the processed claim 26 (i.e. a quasi completed claim). Further, if the claim transaction 12 cannot be adjudicated in real time, then the provider 14 can get an “accepted” status back with the processed claim 26, with the claim transaction 12 being either slated for further processing in the workflow queue of the adjudication engine 402, or for manual intervention potentially by an administrator via an administration module 42. In either event, the provider 14 can access the contents of the database 102 with the claim number (through the portal 47) to follow the progress of the non-real time claim transaction 12 processing. Further, it is recognised that the adjudication engine 402 through interaction with the adjudication modules 404 provides multi-benefit claim transaction 12 processing for such as but not limited to medical, dental, and flexible benefits (HAS) and/or standard benefits, as well as report generation 106 for claim adjudication/payment details. The adjudication engine 402 receives a file of providers 14, a file of service codes, and U&C pricelists from the modules 42, 110 and 108 for updating the adjudication rule sets of the adjudication modules 404.

Once completed, the processed claim 26 is then sent to a payment system 28 (eventually to the payer 30) for payment processing according to a payment clearing schedule, and the processed claim 26 can also be sent back to the provider 14 as feedback in real/batch time to indicate the dollar amount of the processed claim 26, as well as any corresponding adjudication details. The payment system 28 manages the timing of payment requests according to the payment terms for each payee (i.e. patient 36/provider 14 that receives payment due to the adjudicated transaction 12). The payment system 28 can receive a file of paid claims from the database 102 representing successfully adjudicated claims and can provide a file of payments on a periodic basis, such as nightly, and/or the EOB or EOP files (i.e. explanation of benefits/payment) to the requisite actors of the system 10 (e.g. payers 30, providers 14, patients 36). The payment process extracts the adjudicated and unpaid claims 26 from the database 102, marks them as paid if appropriate, and summarizes the payment information for a feed into the accounting payment system of the payer 30.

Further, it is recognised that an exception version of the processed claim 26 can also be sent in real/batch time back to the provider 14, to indicate that the originally submitted claim data of the transaction 12 was not acceptable. The provider 14 can access the reporting module 106 and/or claim associated data in the database 102 through the portal 47, as configured by the system 10, to obtain more detailed information about the processed claims 26 including payment and adjudication details. It is recognised that the module 106 and/or database 102 contents could also supply real/batch time EOB/EOP for the providers 14, which could be given to the patients 36 at the point of sale of the insured services/products, thereby providing electronic point-of-sale connectivity. Other destinations of the completed claim 26 information can be the data warehouse 112 as well as a premium calculation module 114.

Adjudication Server

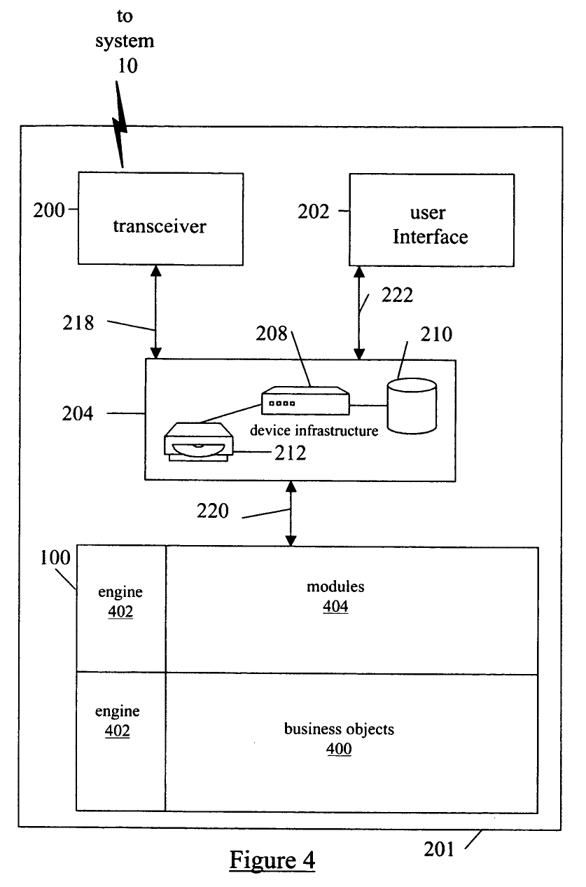

Referring to FIG. 4, the adjudication system 100 is operated on a computer 201 that can be connected to the system 10 via a network connection interface such as a transceiver 200 coupled via connection 218 to a computer infrastructure 204. The transceiver 200 can be used to send the processed claims 26 to the payment system 28, reports to the report module 106, as well as receive claim transactions 12 and other queries from the portal 47, as well as receive updates to the engine 402 and module 404 contents from the modules 108, 110 (see FIG. 1). Referring again to FIG. 4, the adjudication system 100 computer 201 also has a user interface 202, coupled to the device infrastructure 204 by connection 222, to interact with a user (such as the administrator module 42). The user interface 202 includes one or more user input devices such as but not limited to a keyboard, a keypad, a trackwheel, a stylus, a mouse, a microphone, and is coupled to a user output device such as a speaker (not shown) and a screen display 206. If the display 206 is touch sensitive, then the display 206 can also be used as the user input device as controlled by the device infrastructure 204. The user interface 202 can be employed by the administrator of the adjudication system 100 to configure or otherwise maintain the adjudication system 100.

Referring again to FIG. 2, operation of the computer 201 is enabled by the device infrastructure 204. The device infrastructure 204 includes a computer processor 208 and the associated memory module 210 (e.g. database 102). The computer processor 208 manipulates the operation of the network interface 200, the user interface 202 and the display 206 of the computer 201 by executing related instructions, which are provided by an operating system and the adjudication system 100 (including modules 404, engine 402, and business objects 400) resident in the memory module 210. Further, it is recognized that the device infrastructure 204 can include a computer readable storage medium 212 coupled to the processor 208 for providing instructions to the processor and/or to load/design the adjudication system 100 in the memory module 210. The computer readable medium 212 can include hardware and/or software such as, by way of example only, magnetic disks, magnetic tape, optically readable medium such as CD/DVD ROMS, and memory cards. In each case, the computer readable medium 212 may take the form of a small disk, floppy diskette, cassette, hard disk drive, solid state memory card, or RAM provided in the memory module 210. It should be noted that the above listed example computer readable mediums 212 can be used either alone or in combination.

Adjudication System 100

Referring to FIG. 2, the adjudication system 100 is comprised of the adjudication engine 402 used to couple (through interface 403) the adjudication modules 404 to (through interface 401) a series of business objects 400, as further described below. The business objects 400 are also coupled 401 to a plurality of business object hierarchies 406, including such as but not limited to a carrier/recipient hierarchy 408, a benefit hierarchy 410, and a provider hierarchy 412. The hierarchies 406 can be stored in the database 102 for access by the engine 402 and/or modules 404 (of the system 100) during processing of the claim transactions 12. It is noted that the business objects 400 can represent a plurality of claim transactions 12 (e.g. claim A, claim B, etc.) to provide parallel processing of the claim transactions 12 by the system 100. It is also recognised that a plurality of different engines 402 can be implemented by the adjudication system 100, in order to provide system 100 flexibility for multiple carriers (payers 30) in conjunction with selected coupling of the hierarchies 406 and modules 404. It is recognised that the business objects 400 (or a selected portion thereof) can be reused to represent data instances for different subsequent claim transactions 12, respective selected subsets (portions) of the business objects 400 can be used with appropriately selected adjudication modules 404 (as assigned by the appropriate adjudication engine 402—based on for example payer 30 and/or claim type), and updates to the module 404 contents and affected business modules 400 (if any) can be implemented by the adjudication system 100 as required. Accordingly, it is recognised that the adjudication engine 402 is the interface between the separated modules 404 (e.g. functions/methods/actions for data) and the business objects 400 (i.e. data instances of the claim transaction 12).

The business objects 400 provide the context in which the rules (e.g. methods) of the modules 404 and/or engine 402 will be evaluated. The methods of the modules 404 are attached to Business Objects 400 via the adjudication engine 402, such that these methods perform calculations in the context of the Business Object 400 or retrieve information about the Business Object 400 that is not available as an Attribute of the business object 400. It is recognised that the business objects 400 interact with the database 102 as instances of specific claim transactions 12 and their data contents are operated by the modules 404 and engine 402, as further described below, in order to produce the processed claim 26. The adjudication engine 402 coordinates application of the modules 404 and their associated actions/methods/functions (e.g. rule sets) to the claim data instances represented by the data objects 400. The business objects 400 can be defined as representing data containers of the claim transaction 12, such that the data objects 400 are coupled to the database 102 for data retrieval and persistence purposes, as well representing a predefined data structures for the claim data instances. Business objects 400 interact with the modules 404 and hierarchies 406, as given further below.

The adjudication system 100 is designed to use a common enrollment and eligibility system across the different lines of business (dental, drug, emergency dental, medical vision, extended health, short term disability, etc. . . . ). Different claim transaction 12 types (e.g. dental, drug, etc. . . . ) are used to submit claims through the portal 47 for the different lines of business of the payers 30. The adjudication engine 402 (in conjunction with the modules 404 and business objects 400) adjudicates requests for payment for the service provider 14 rendering a service event to a recipient. For example, the adjudication system can adjudicate a medical claim submitted by a doctor for suturing John Doe's knee, a dental claim submitted by a dentist for performing a root canal on Bob Smith, and/or adjudicate a drug claim submitted by a pharmacist prescribed by a doctor for dispensing an antibiotic to Jane Doe. It is recognised that the claim transaction 12 can contain claims associated with one or more lines of business.

Adjudication Engine 402

The engine 402 is composed of components to perform the following tasks, such as but not limited to:
Accept an EDI claim in an existing standard format (CPhA 3, CDA 2 or 4, provincial medical format)
Or
Accept an XML EDI claim in an XML format;
Edit check the fields in the arriving claim transaction 12;
   These two steps produce a claim object or series of objects 400 encapsulating the information in the EDI or XML claim;
Validate claim level data fields and associated business objects 400
   Initial loading of recipient data (history, plan definitions, . . . );
For each claim item within the claim transaction 12
   Validate eligibility of the claim item object and associated business objects 400
      Perform override logic for various data and methods attached to the business objects 400;
   Check coverage (is the claim item as a whole eligible)
      do exclusion and inclusion checks first, if no answer then check base plan as represented by the hierarchies 406;
   Determine base pricing
      includes ‘special relationship’ pricing, plan specific pricing;
   Adjudicate (e.g. should more or less than base pricing be paid?)
      Retrieve a recipient's claims experience
      Run the compiled English language like rules that examine attributes on the business objects for the current claim and those from claims experience;
   Have the fiscal rules applied (have decided how much to pay, now who pays what portion)
      Retrieve a recipient's, subscriber's, department's, and company's fiscal experience
      Run the compiled fiscal rules for deductibles, copay, coinsurance, etc.;
   COB (coordination of benefits—has this claim transaction 12 been partly paid by another insurer)
      If a recipient is covered by another insurer also who is primary then COB determines how much the secondary insurance company should pay to share costs.
      Example—simplest algorithm is to pay what is left over up to a maximum of what would have been paid if this insurer was primary; and
   Have determined the DUR/DUE (drug utilization review/eligibility—will this drug harm the recipient)
      Done as a separate thread, results combined after all processing complete;
Combine responses for each claim item into the overall processed claim 26; and
Format the response in the proper format based on the format of the arriving claim transaction 12.

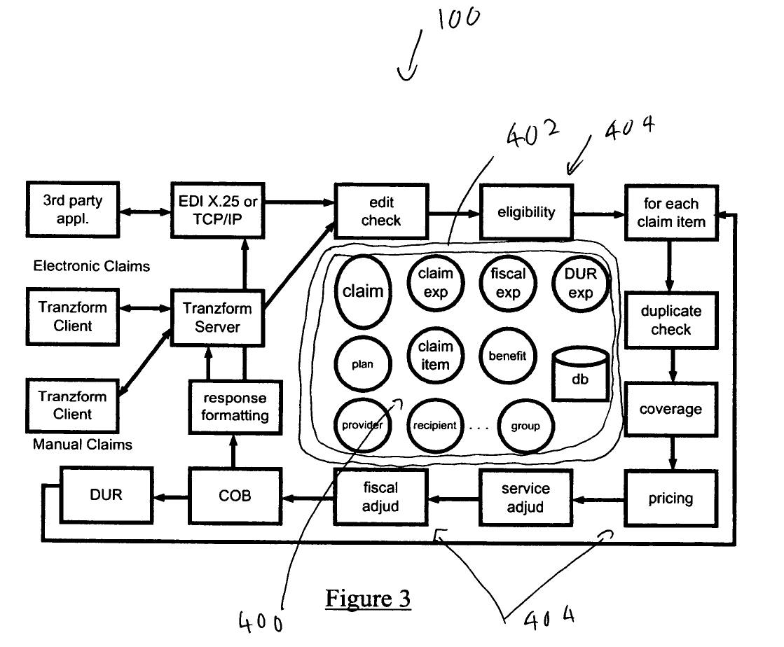

The adjudication engine 402 is configured to describe both the business objects 400 that are being processed (inner circles of FIG. 3), and the adjudication modules 404 doing the processing of the data instances (of the claim transaction 12) in the business objects 400 (outer squares in FIG. 3). For example, during claim transaction 12 processing workflow of the engine 402, once the specified business object 400 or module 404 is first encountered the object 400/module 404 is loaded (i.e. associated with the specific claim transaction 12) but after that there is no further loading performance penalty. Further, the configuration of the engine 402 can be used to coordinate changes/additions/deletions of the plan components, modified rules of the modules 404 and related hierarchies 406 (through the business objects 400). An example adjudication engine 402 configuration is given in Appendix A. Further, the configuration of the adjudication engine 402, based on receipt of a specific claim transaction 12 by the system 100, selects the subset of plan components (from the available hierarchies 406 set), and selects the subset of the rule sets/block and individual rules to be evaluated (from the available modules 404 set) based on adjudication criteria, such as but not limited to carrier-recipient hierarchy 408 contents, claim type, etc. The selected subsets are then loaded by the adjudication engine 402 into an ordered set of individual rules that will each be evaluated in turn during processing of the received claim transaction 12 (e.g. through the portal 47). Further, for example, if an error is encountered in evaluating a rule of the ordered rule set, such as in accessing a business object 400 or attribute that doesn't exist in the adjudication system's 100 configuration, then an error message is logged in the database 102 and the rule is ignored.

Further, it is recognised that the administrator of the adjudication system 100 can update (e.g. via the module 42) the configuration of the adjudication engine 402 instance and/or the rules of the associated modules 404. The amended rules confirmed for validation with that particular adjudication engine's configuration. As an example, an adjudication engine 402 could be updated with new attributes for a given business object 400, such as adding a SalaryIndicator to the Provider object. The updated grammar and existing rules (plus any newly added rules) of the respective modules 404 would validated against the adjudication engine 402 instance. If there were misconfigurations, either in the Rule grammar or the adjudication engine 402 configuration grammar, any errors could be identified by the module 42 before the updates modules 404 and engine 402 are added to the adjudication system 100.

It is noted that all of the available modules 404 of the adjudication system 100 may not relevant for all lines of business. As examples, a public medical claim adjudication engine 403 may have no need for fiscal adjudication rules (for copays, deductibles, etc), and DUR/DUE is not applicable to the adjudication engine 403 for dental claims. Also, it is noted that some modules 404 potentially apply across the lines of business, such as fiscal rules allowing combined deductibles/maximums for dental, pharmacy, and vision for example, while others are specialized per line of business (pricing medical claims is different than pricing pharmacy claims).

Claim Transaction Lifecycle

Claim transactions 12 are submitted to the adjudication engine 402 for adjudication using several different methods, such as but not limited to:

1. EDI Claim Submission

This is the claim transaction 12 submitted by the third party applications 18 (see FIG. 1) using an existing EDI claim format standard such as CPhA 3 or CDA 2 or 4, that sends claims in as ASCII data over the system 10 network of some sort, such as direct dial modems, X.25 network, a private TCP/IP network, or the public TCP/IP network (Internet).

2. Manual or Paper Claim Submission

This is a claim filled out on paper, such as by the patient 36 (see FIG. 1) and sent in via fax or mail. Keypunch operators then enter the claim into the adjudication system through, for example the portal 47, using the manual claim submission screens. This process can allow overrides and can enable the ignoring of desired rules under the user's control.

3. Client Submitted Electronic Claim Submission

This is the submission of the claim transaction 12 the same as the manual claim submission except that the client (either the patient 36, provider 14, or company clerk of the payer 30 enters the claim transaction through the portal 47 using the manual claim submission screens rather than sending the paper claim in to the insurer/payer 30.

It is recognised that each claim transaction 12 can have several possible states while undergoing adjudication by the adjudication engine 403, such as but not limited to states:
Processing error—held for later processing—highest precedence state I.E. system 100 down now or didn't find price for covered procedure;
Refused—invalid claim that is not saved;
Held—manual intervention required;
Paid as zero—accepted but paid no money for it;
Reduced—paid less than asked;
Accepted—paid what was asked; and
Implicitly accepted—paid what was asked, the starting state—lowest precedence state.

When adjudicating the claim transaction 12, its state can be modified by the adjudication engine 402 from the lower precedence state to the higher precedence state (i.e. from implicitly accepted to refused) with an associated explanation code. However, state changes that attempt to go from a higher precedence state to a lower precedence state can be ignored unless they are part of an override associated with manual claims processing.

One example operation of the adjudication engine 402 for claim transaction 12 lifecycle is where an insured service event can have several claims submitted for adjudication, however only one of those claims can be in an accepted, reduced, or paid state at a time. For example, the claim transaction 12 can be submitted for a service event and refused. The claim transaction 12 can be corrected and resubmitted and paid as zero. A reassess claim transaction 12 can then be submitted (or a delete claim then add claim) that is accepted but reduced. Finally, the claim transaction 12 can be deleted. If an add claim transaction 12 is submitted for a service event and that claim already exists in an accepted, reduced, or paid as zero state then the newly submitted claim transaction 12 should be refused as a duplicate. Similarly, if a delete or reassess claim transaction 12 is submitted and that claim does not exist in an accepted, reduced, or paid as zero state, then the newly submitted claim transaction 12 should be refused.

Business Objects

Referring again to FIG. 2, in general, business objects 400 are the data objects that contain the state of the claim transaction 12 currently being adjudicated by the adjudication system 100. Business Objects 400 can be defined as domain-specific objects that handle some aspect of a business process or category of business information. The Business Objects 400 are intended to be smart agents with guarded state and guaranteed behavior. The Business Objects 400 can be promoted as the components of a middle tier between a data repository and the end-user application, such that the Business Objects are stable, reusable models and the user applications are the evolved views. The business objects 400 can call/access others of the business objects 400 of a related transaction 12. The business objects 400 contain no (or minimal) business logic and serve as data repositories for the data associated with the transaction 12. The business objects 400 know how to persist/restore themselves to the database 102 and can be filled in a lazy evaluation manner. If a specific business object 400 is not referenced during processing of the transaction 12, the business object 400 will not access the database 102. The Business Objects 400 can be pooled to help reduce heap use/fragmentation and improve performance of the adjudication system 100. It is recognised that Claim and ClaimItem (claim contents of the transactions typically contain claim, claim line items claim line sub-items) of the transaction 12 are specialized business objects 400. An example of a claim with claim line items can be found in Appendix B. The claim is the entry point to all business objects 400 within the system 100 according to the specific transaction 12, and has a claim state as discussed above and EOBs. ClaimItem is associated with the business objects 400 of the specific transaction 12 and has a claim state and EOBs as well, although the ClaimItem does not serve as an entry point into the adjudication system 100.

Referring again to FIG. 2, the methods, functions, and/or actions performed by the modules 404 (with coordination from the adjudication engine 402) can contain rules such that the structure of Rules is, such as but not limited to a simple IF {condition(s)} THEN {action(s)} statement where the conditions are expressions that result in a True or False answer and the actions are methods of the modules 404 that are performed on the claim data contents of the business objects 400 if the conditions are true. The elements that comprise the conditions and actions of the modules 404 are specific to the implementation of the adjudication engine 402 selected by the adjudication system 100 to process the claim transaction 12, for example selected based on a specific carrier. The methods/functions/actions of the modules 404 are configured such that they interact with information on, such as but not limited to:
Business Objects 400 such as a specific Claim;
Attributes associated with each Business Object 400 such as a Recipient;
Methods associated with each Business Object 400 (e.g. calculations based on the Recipient's claim transaction 12 history);
Global functions such as those used to manipulate or compare data (e.g. performed by the modules 404 and/or the engine 402);
Actions such as Pay or Refuse; and
Operators for comparisons and arithmetic.

Business Objects 400 are the objects to which claim data information of the claim transaction 12 is attached. An individual Claim (e.g. sent from the provider 14) is an example of the Business Objects 400. Attached to the Claim is information such as the identity of the Claim's recipient and the service for which the Claim is being made. The Attributes and Methods attached to the Business Objects 400 are referenced in the Rules of the modules 404 using, for example, an object.attribute and an object.method syntax respectively. Attributes are the pieces of information attached to the Business Object 400. Attributes have values that can be used for comparisons or calculations, depending on its data type. Read only attributes cannot be assigned new values. An Enumeration Type may be assigned to an Attribute. You can select from a list of values associated with the Enumeration Type when creating an expression using the Attribute. A Value Group Type may be also be assigned to the Attribute. You can select from a list of grouped values associated with the Value Group Type when using a method that accepts a list of values. Parameters for Methods and Functions can be any element or expression that has a compatible Data Type. There can be two special types of parameters, Field and Array. A Field parameter is a reference to the Attribute itself, not the value returned by the Attribute. Field parameters are used when multiple instances of the Business Object 400 are used in the Method's underlying calculation. For instance, the Field parameter of Amount is used when calculating a total of the Claim Amount attribute in a Recipient's history. A Data Type is associated with each element in the Business Objects 400. Use of Elements with incompatible data types in the Methods and expressions of the modules 404 is discouraged through the adjudication engine 402 configuration.

Business Object History (Experience Business Objects 400)

Referring to FIG. 3, there are a number of business objects 400, including experience objects. These business objects 400 that require historical information, for auditing and/or reporting purposes, can have two tables. The first holds the currently active records only, while the second table holds the active records plus historical records. For example, the provider business object 400 would interact with two tables, PROVIDER and PROVIDER_HISTORY. Examples of these two tables are as follows.

PROVIDER

PROVIDER_ID
VERSION
PROVIDER_NUMBER
PROVIDER_TYPE
EFFECTIVE_DATE
EXPIRY_DATE

PROVIDER_HISTORY

PROVIDER_ID
VERSION
PROVIDER_NUMBER
PROVIDER_TYPE
EFFECTIVE_DATE
EXPIRY_DATE
MODIFIED_DATETIME, MODIFIED_BY,
MODIFIED_REASON

PROVIDER

| provider_id | version | provider_number | provider_type | effective_date | expiry_date |
|---|---|---|---|---|---|
| 11111 | 1 | 12345 | DENT | 1995/01/01 | 2099/12/31 |

PROVIDER_HISTORY

| provider_id | version | provider_number | provider_type | effective_date | expiry_date | modified . . . | modified_date |
|---|---|---|---|---|---|---|---|
| 11111 | 1 | 12345 | DENT | 1995/01/01 | 2099/12/31 | initial | 1995/01/01 |

PROVIDER

| provider_id | version | provider_number | provider_type | effective_date | expiry_date |
|---|---|---|---|---|---|
| 11111 | 2 | 12345 | DENT | 1995/01/01 | 1999/12/31 |

PROVIDER_HISTORY

| provider_id | version | provider_number | provider_type | effective_date | expiry_date | modified . . . | modified_date |
|---|---|---|---|---|---|---|---|
| 11111 | 1 | 12345 | DENT | 1995/01/01 | 2099/12/31 | initial | 1995/01/01 |
| 11111 | 2 | 12345 | DENT | 1995/01/01 | 1999/12/31 | dropped by association | 2000/01/14 |

PROVIDER

| provider_id | version | provider_number | provider_type | effective_date | expiry_date |
|---|---|---|---|---|---|
| 11111 | 3 | 12345 | DENT | 2001/01/01 | 2099/12/31 |

PROVIDER_HISTORY

| provider_id | version | provider_number | provider_type | effective_date | expiry_date | modified . . . | modified_date |
|---|---|---|---|---|---|---|---|
| 11111 | 1 | 12345 | DENT | 1995/01/01 | 2099/12/31 | initial | 1995/01/01 |
| 11111 | 2 | 12345 | DENT | 1995/01/01 | 1999/12/31 | dropped by association | 2000/01/14 |
| 11111 | 3 | 12345 | DENT | 2001/01/01 | 2099/12/31 | reinstated | 2001/01/15 |

PROVIDER

| provider_id | version | provider_number | provider_type | effective_date | expiry_date |
|---|---|---|---|---|---|
| 11111 | 4 | 12345 | DENT | 2000/07/01 | 2099/12/31 |

PROVIDER_HISTORY

| provider_id | version | provider_number | provider_type | effective_date | expiry_date | modified . . . | modified_date |
|---|---|---|---|---|---|---|---|
| 11111 | 1 | 12345 | DENT | 1995/01/01 | 2099/12/31 | initial | 1995/01/01 |
| 11111 | 2 | 12345 | DENT | 1995/01/01 | 1999/12/31 | dropped by association | 2000/01/14 |
| 11111 | 3 | 12345 | DENT | 2001/01/01 | 2099/12/31 | reinstated | 2001/01/15 |
| 11111 | 4 | 12345 | DENT | 2000/07/01 | 2099/12/31 | actually reinstated July 1 | 2001/02/08 |

After the provider complained, saying his reinstatement was actually back-dated to July 1.

Note how in all cases changes to the provider information is retained. Even if an error is made (such as version 3 in the above example), that error is superseded by a new version of the record for use in processing, but the audit trail showing all the changes made are retained.

The provider business object 400 would select from the PROVIDER table first (SELECT*FROM PROVIDER WHERE PROVIDER_NUMBER=‘x’) and examine the single record returned for its effective and expiry dates against the service date of the claim. If the record found was valid, the business object 400 is done. If no record was found, then the provider is not valid. If the record found was out of date, then select from the PROVIDER_HISTORY table ordering by version (SELECT*FROM PROVIDER_HISTORY WHERE PROVIDER_NUMBER=‘x’ ORDER BY VERSION DESC’). Examine the records in turn until a record is found that is valid for the claim transaction's 12 service date. If none are found, then the provider is not valid. When storing the claim transaction 12 information in the database 102 by the business objects 400, save the PROVIDER_ID and VERSION. The version field is used to order the records, with a higher version always being a later record. The effective and expiry dates perform a similar function, but cannot compensate for errors in data maintenance. For example, if only the effective and expiry dates are used then any error information is lost when the record is replaced.

The above allows reports and other programs to select the latest information always (join against the PROVIDER table using the PROVIDER_ID field, ignoring the VERSION field) or the information that was current when the record was saved (join against PROVIDER_HISTORY using both the PROVIDER_ID and VERSION fields). As well, the latest information valid for the period when the record was saved can be retrieved as well (join against PROVIDER_HISTORY using PROVIDER_ID and EFFECTIVE_DATE<=SERVICE_DATE<=EXPIRY_DATE ORDER BY VERSION DESC).

When the maintenance screens of the portal 47, through for example the maintenance module 108 (see FIG. 1), are used to maintain the business objects with tables, an insertion (or update) should increment the version number and insert the record into the business object history table and then update the single record in the business object table. Note that the older versions in the history tables are those records that can be purged, simplifying the purging criteria used throughout the system.

The Experience business objects 400 are almost entirely read-only objects that collect a set of records that are normally historical. These business objects 400 are called ‘experienced’ since claims can arrive out of chronological order, meaning that there can be records within the experience table that have a newer service date than the claim transaction 12 being adjudicated. The only ‘normal’ time an experience record is modified is when its status is set from active to inactive, meaning that a new claim transaction 12 has superseded this experience record. This can happen in the case of a reassess or delete claim. There may be other ‘abnormal’ updates, such as batch updates of claims experience data, accumulator modifications, etc., that may modify other information.

The claims experience table of the experience business objects 400 holds details of all successfully adjudicated claims (i.e. processed claims 26). The individual benefits adjudicated are stored in the table as long as, for example, the edit checks, eligibility, coverage, and pricing modules 404 are successful, as directed by the adjudication engine 402. If a benefit is refused after these modules 404 have processed it, pays zero, pays some amount, or pays what was asked, then the benefit is stored here. Once the claim has been stored in the claims experience business object 400, the associated claim transaction 12 can only be reassessed or deleted. The time period records are retained depending on the purging job details, which is based upon what the adjudication rules contain (those rules assigned and ordered by the adjudication engine 402). For example, if an adjudication rule for root canals checks for similar claims in the last 18 months, those similar claim records must be retained for at least 18 months.

The fiscal experience table of the experience business objects 400 holds details of who pays what portions of the benefit's payable amount. If amounts are paid, a record is stored here. Note that a pay zero benefit has no record stored since nothing has been paid. Longer-term fiscal records may be summarized after a set time period. For example, after 12 months, fiscal records belonging to a benefit group may be rolled up into a summary record as the detail records are purged. This will only be done if performance requirements make it necessary.

DUR experience of the experience business objects 400 is very similar to claims experience except that the period claims are retained depends on the prescription details and all validly submitted prescription drug claims are stored here. All prescription drug claims have to be stored as recipients may pay for the prescribed drug themselves even if it's not eligible for coverage under the existing plan. The DUR module 404 has to consider these non-eligible prescription drugs, although the claims experience component does not.

Modules

Referring to FIG. 3, in general, the modules 404 contain methods/functions/actions for applying against the data instances of the business objects 400 representing the claim transaction 12. In the adjudication system 100, the modules 404 and associated business objects 400 are configured by the adjudication engine 402 in response to the received claim transaction 12. The structure of Rules content of the modules 404 can be simple IF {condition(s)} THEN {action(s)} statements where the conditions are expressions that result in a True or False answer and the actions are methods that are performed on the business objects 400 if the conditions are true. The elements that comprise the conditions and actions are specific to the implementation of the adjudication engine 402. Conditions are expressions that result in a True or False answer. The expressions are comprised of the rule elements. Conditions can be as simple as (OBJ.A=1) or as complicated as for example:

((OBJ1.A+OBJ1.B)=2) OR ((OBJ1.D=10) AND (OBJ2.E=OBJ2.F)) OR (OBJ.FUNCTION(A,B)=25).

The rules of the modules 404 can have multiple conditions joined together by logical operators and each condition can be nested with other conditions. Actions are the method elements that are executed by the rules processing of the adjudication engine 402 when all the conditions are true. Actions may manipulate values but do not return a value. Actions may or may not require parameters. As described above, the methods of the modules 404 may also be attached to Business Objects 400. These methods perform calculations in the context of the Business Object 400 or retrieves information about the Business Object 400 that is not available as an Attribute. The Attributes and Methods attached to the Business Object 400 are referenced in the Rules using the object.attribute and object.method syntax respectively. Methods and Functions are used to return a calculated value, return a state or perform an action on the business object 400 contents. Functions can be Methods that are not attached to the Business Object 400 and as such may not have a context other than the values passed in as parameters. Parameters for Methods and Functions can be any element or expression that has a compatible Data Type. There are two special types of parameters, Field and Array, as described above. Operators of the modules 404 (and engine 402 if desired) are used when comparing two values of the business objects 400 or joining two conditions. The logical operators AND, OR, AND NOT, OR NOT and NOT and other operators such as EQUALS and NOT EQUALS are examples of operators. While these operators are an important part of building rules, they may have different labels and allowable data types for any given business environment so are therefore configurable. Value Groups are special elements that allow a set of values to be referenced concisely and conveniently in the Rules. Any Method that accepts a parameter array (list of values) will accept a Value Group reference providing the Attribute in the expression that has a Value Group Type assigned to it. A typical use of Value Groups is in a Method that determines whether an Attribute is equal to any value in a list of values. Rather than specifying the list explicitly a Value Group can be defined that contains the list of values. A reference to the Value Group can then be passed as a parameter to the Method rather than the list of values. Enumerations are simply a list of possible values. Attributes can be assigned an Enumeration Type, which will associate the Attribute with the list of possible values for that Enumeration Type. Error Codes are values belonging to the Error Code Enumeration Type. Literal Values are numbers and strings and can be used anywhere the literal value's Data Type is compatible.

The insurance plan as described in the hierarchies 406 between the provider 14, recipient 36 and payer 30 (e.g. carrier) consists of several modules 404, for example such as but not limited to:

Eligibility;

Coverage;

Pricing;

Adjudication Rules;

Fiscal Rules;

COB; and

DUR.

A plan module 404 can has a different form based on what type of module 404 it is. As well, a plan module's 404 operation may be modified based on the line of business and/or version of claim (dental, drug, etc.). The plan modules 404 are retrieved from the various hierarchies 406 by the adjudication engine 402 during the eligibility validation of the business objects 400 (used to represent the claim transaction 12 data instances) and coalesced into the set of plan modules 404 that will be processed during the adjudication process of the adjudication system 100. The precedence used when coalescing the plan modules 404 is configurable by the administrator of the adjudication system 100.

Eligibility Module

The eligibility module 404 checks the eligibility of the claim transaction 12 data, such as but not limited to patient details, provider details, and services details. The eligibility module 404 can confirm if the patient 36 is covered (i.e. part of an insurance plan), can be done in real time, and can be integrated in an enrolment process (not shown) of the patients 36 and the payer 30. Eligibility module 404 answers the question ‘is each of the individual business objects 400 referred to in the claim item valid?’ This eligibility module 404 instantiates each of the business objects 400 using information provided from the claim object 400. Each business object 400 is responsible for collecting and collating any plan information attached to itself. This involves retrieving the plan information from the database 102, ordering and coalescing the plan information appropriately. The eligibility module 404 is processed once for each claim transaction 12, regardless of the number of claim items. Because of this, the benefit eligibility is deferred to the next module.

Coverage Module

The coverage module 404 checks eligibility for each individual benefit and also answers the question ‘is this claim item as a whole eligible for payment?’ This function inspects the plan sets, including any inclusion and exclusion coverage exceptions, to determine coverage. This is also the module 404 that checks for a duplicate claim transaction 12 based on configured service event matching criteria. The coverage module 404 determines if an alternative procedure exists for the procedure submitted. This is for the case, for example, of brand versus generic drugs in pharmacy systems, amalgam versus acrylic fillings in dental. The coverage plan determines whether the original or alternative procedure is the one adjudicated. Emergency dental claims can (again, depending on the coverage plan) alter the method sued to determine coverage. Usually, more procedures are covered for emergency dental claims, although the maximum limits are usually reduced and treatment plans are required. The coverage module 404, and the following modules, are processed once per claim item, potentially multiple times per claim transaction 12. Rules may be attached/evaluated by the coverage module 404 for complex criteria like:

Not covered when subscriber 65; and

Covered if subscriber dead and recipient under 21 (or 25 when attending school).

Pricing Module

The pricing module 404 answers the question ‘what should be paid in total for this claim item assuming no exceptional circumstances?’ There are two components to determining the pricing, the first is finding the appropriate fee schedule, the second is using the appropriate pricing method. The fee schedule is determined based on:

Subscriber province of residence (if available);

Provider province of residence (if available); and

Carrier level default.

The values returned from the fee schedule depend on the claim type being adjudicated. This ranges from a wholesale price, a markup percentage or amount, plus lab and professional fee amounts for pharmacy claims, through to a base price by provider specialty for dental.

The default pricing method just uses the fee schedule selected above and capping the asked for amount at this value. Selecting (creating if necessary) a different pricing module 404 can modify the pricing method and fee schedule determination. For claim transactions 12 with multiple prices (such as dispense fees in CPhA 3 and lab fees in CDA 4), these other prices are either capped at a fixed and/or percentage amount of priced service amount. Rules may also be attached to the pricing module 404 for performing complex pricing calculations, such as the lab fee amount is capped at 50% of the benefit amount or $10.00, whichever is more.

Further, Once eligible, the pricing module 404 can have a repricing process for repricing to determine an agreed upon dollar amount for the insured services. The repriced claim transaction 12 is then sent to an adjudication module 404 for adjudication, which processes the repriced claim data 22 according to business rules to determine what portion of the repriced claim data 22 should be paid out, if any. The adjudication module 404, described below, generates adjudication results for the valid processed claim 26, and generates exception records for an invalid processed claims 26.

For example, repricing is demonstrated by example, where the patient 36 has a dialogue with the provider 14 concerning medical services/products, for example $1000. The patient 36 pays for a deductable 200, such as $50, as established by the system 10. The provider 14 then requests for real time EOB, EOP (processed claim 26) from the adjudication system 100 for the remainder of the claim, $950, as an appropriate claim transaction 12. The engine 402 performs the eligibility for the claim transaction 12. The repricing module 404 uses a PPO network database to reprice the claim transaction 12 as per preagreed contracted discounts, for example a 20% discount leaving the claim now worth $800. The engine 402 then redirects the repriced claim transaction 12 to the adjudication module 404, which performs the adjudication process to determine according to adjudication rules what the related payer 30 will pay. If acceptable by the fiscal module 404, then the processed claim 26, now decided as $750 to the provider 14 and $50 from the patient 36, is directed to the payment module 28. As well, the provider 14 is routed the processed claim 26 via the portal 47. The payer 30 is also informed of the processed claim 26. The various funds to cover the processed claim 26 are deposited in the related banks, as per clearing house 58 payment procedures as an EFT, check, account deposit, B2B funds transfer, and other ePayment procedures.

Adjudication Module

The adjudication module 404 contains adjudication rules that are used to define ways in which the price paid for this claim item (of business object 400) should be adjusted either up or down. For example, performing the procedure in the night rather than during normal business hours may pay a premium. Or performing two procedures in the same visit may pay less for the second procedure since the patient 36 and provider 14 are both already present at the location. Adjudication rules of the adjudication module 404 can be grouped into sets and have four main components, for example such as but not limited to:

Filtering criteria—execute this rule set or not based on current claim item criteria;

Period—what claim items to look at in claim experience;

Condition—perform the actions or not; and

Actions—how the rule affects the claim item status.

It is noted that the filtering criteria taken care of by how the rule attached to the business objects 400.

The adjudication rules adjudication module 404 can be the English-language like constructs, with the grammar being defined of simple nouns, used to access attributes on the various business objects 400, complex nouns, which are functions that operate on more than a single attribute, and verbs, controlling how the action affects the claim item status. Any attributes available on the business objects 400 are accessible to the rule grammar. The rule grammar is easily extensible through a configuration file closely resembling the configuration files used for the business objects 400. The difference is that grammar operations (such as ‘within X days’ or the plus operation) are mapped to Java classes, for example, implementing the appropriate logic.

Fiscal Module

Fiscal rules of the fiscal module 404 are similar in concept to the adjudication rules, but they have a much more restricted grammar. There are certain fiscal rule algorithms, such as deductibles, maximums, copays, coinsurances, etc, plus the parameters those algorithms require. The components of a fiscal rule can be such as but not limited to:

Filtering criteria—execute this rule set or not based on current claim item criteria;

Period—what claim items to look at in fiscal experience;

Fiscal Algorithm—what type of fiscal processing is performed; and

Parameters—the parameters required by the fiscal algorithm.

It is noted that the filtering criteria taken care of by how the rule attached to the business objects 400.

Fiscal rule types can include types such as but not limited to:

Deductibles—individual, couple, family;

Maximums—individual, couple, family;

Coinsurances—pay % of claim value per claim;

Capped—capped at a maximum amount;

Tiered—pay 5%<$10, $10<4%<$20, 3%>$20;

Sliding—as tiered, but cumulative;

Copays—pay $x per claim; and

Capped, Tiered, Sliding.

For example, HCSA (Health Care Spending Accounts) are currently treated as a maximum with a very broad coverage plan component. Further, deductible rollovers, other plan anniversary special cases, are performed with by a batch job that adds appropriate adjustment records to fiscal experience. Emergency dental services can select a different set of fiscal plan modules 404, as required.

COB Module

Coordination of benefits as primary or secondary is enabled or disabled at the plan level and cannot be overridden on an individual level. This COB indicator of the COB module 404 is used to simply refuse claims without further processing when required, so if primary COB is disabled and a primary claim arrives, the claim will be refused. Likewise if secondary COB is disabled and a secondary claim arrives. This COB functionality configurable, except for secondary claims since it costs the insurer less than what they would have otherwise paid. Also, the adjudication system 100 may mark this recipient as having COB coverage if a secondary claim is processed. If the claim transaction 12 passes this initial check of the COB module 404, then the actual recipient is checked to see if they have primary or secondary coverage as appropriate. A primary claim processes as normal. If a secondary claim is received for a subscriber or recipient that does not have secondary coverage listed, that claim transaction 12 may be refused as described above by application of the rules of the COB module 404. There are more complicated methods to determine primary or secondary coverage, such as the CHLIA algorithm, that can be used instead of the manual setting described above. Whether automatic or manual, setting COB definitions of the COB module 404 rules is performed when maintaining the subscriber and recipient information, for example by an administrator of the adjudication system 100.

Further, if no plan information is attached to COB, as determined of the claim transaction 12 (represented by the business objects 400) by the COB module 404, the primary plan is assumed to cover all claims currently. Note that there may be multiple secondary coverage insurers. Once it has been determined that a secondary claim is covered, the claim transaction 12 is adjudicated as normal. The COB module 404 then determines the COB algorithm to use to determine allowable pricing. There are multitudes of possible algorithms, with the simplest being pay what is asked up to a maximum of what would have been paid if this claim transaction 12 was primary instead of secondary. Note that this results in paying nothing as a secondary insurer if the benefit would not have been eligible as the primary insurer. Further, blue on blue COB may be performed automatically by the COB module 404 when appropriate. Blue on red COB is not. The blue on blue COB setting is configurable so that if the subscriber/recipient doesn't bother submitting the COB claim it will reduce costs for the secondary insurer.

DUR Module

Drug Utilization Review (also known as DUE for Drug Utilization Eligibility) of the DUR module 404 only applies to drug claim transactions 12, and attempts to answer the question ‘will this drug harm the recipient based on factors such as age, gender, other drugs being taken, etc’. Our DUR module uses FDB (First Data Bank) data and algorithms. There are two possibilities for DUR: first where all claim transactions 12 submitted are saved to the DUR experience business object 400, second where only accepted claim transactions 12 are saved to the DUR experience business object 400. In the first case, if a recipient refuses the drug because it's not eligible the DUR experience business object 400 as examined by the DUR module 404 will show that the recipient has taken the drug. There is no incentive for the pharmacist to delete the claim transaction 12, since it does not affect his compensation. In the second case, the recipient may take the dispensed drug by paying for it himself. The DUR experience business object 400 will not show this drug, potentially resulting in a harmful drug being prescribed later. Due to the potential consequences, the first option may be recommended and may be implemented as the default. It is to remember that, in either case above, the DUR module 404 can only perform its checks on those drugs that are submitted to this system 10. If the recipient is currently taking another drug, perhaps dispensed from a hospital, that is not submitted to this system 10 (i.e. part of the database 102, the DUR module 404 cannot check for any interactions with the unlisted drug.

Business Object Hierarchies

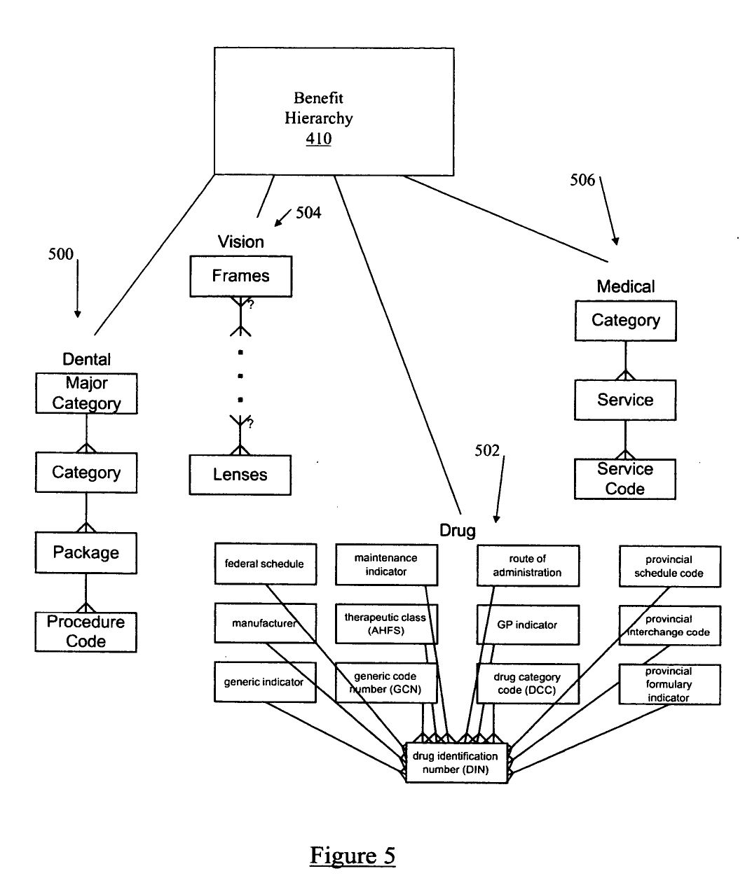

Referring to FIGS. 2 and 5, there are several separate business object hierarchies 406 that allow the inheritance and overriding of attributes among the different levels in a single hierarchy 406. The hierarchies 406 provide the pre-defined organisation (e.g. as set up by a plan administrator) of the business objects 400 selected to represent the claim transaction 12, according to the insurance plan to be used by the adjudication system 100 to process the claim transaction 12. The modules 404 can use the hierarchies 406 to assist in applying the business logic of the modules 404 to the data instances of the business objects 400 associated with the claim transaction 12. For example, if an attribute of the business object 400 is not defined at a lower level, the business object 400 inherits the attribute from the levels above. For example, if a carrier defines a default pricing algorithm and no other lower level defines any pricing algorithm, querying any business object 400 by the modules 404 and/or engine 402 lower in the hierarchy 406 for it's pricing algorithm returns the pricing algorithm attached to the carrier business object 400. Further, it is recognised that the hierarchies 406 can be used by the modules 404 to select the appropriate business objects 400 used to represent the claim transaction 12.

Carrier—Recipient Hierarchy 408

The carrier—recipient hierarchy 408 is the most visible inheritance relationship within the adjudication system 100. This hierarchy 408 has the following levels, from the coarsest to the finest, such as but not limited to:

| Private | Public |
|---|---|
| Carrier | Ministry |
| Company (sometimes known as | Type (Medical, Drug, EHC, . . . ) |
| sponsor or policy) | |
| Department (sometimes known | Plan (RCMP, Fair Pharmacare, . . . ) |
| as subgroup or division) | |
| Subscriber | Household |
| Recipient (sometimes known as | Recipient |
| patient) | |
| Legal | Legal |

Part of the recipient business object 400 is associated history summary information. This would include tooth history information for a dental adjudication system, for example, so that procedures performed on an extracted tooth will be refused appropriately. As well, lifetime accumulators are kept for fiscal experience claims that are purged from the system 100. Note that the carrier level is the top most level and defines a base set of plan modules 404 that cover all possibilities which will be used if not overridden by the higher precedence layers lower in the hierarchy. As well, the carrier level is used as a security barrier for privacy, where all users (except for the system administrator) are restricted to accessing a single carrier only.

The intention of the business objects 400, defined at the carrier level, is to hold, usually based upon the recipient's and the provider's geographic locations, any special legal requirements that apply to the claim transaction 12. preferably, these legal requirements cannot be overridden. Currently, a use of this is for the Quebec RAMQ law which affects the fiscal rules rather than eligibility. It is expected that the governments will likely pass laws in the future restricting the public insurers (i.e. province sponsored coverage for seniors, social service recipients, etc.) to be payers 30 of last resort. This would mean that the claim transaction 12 submitted as a primary claim to a public insurer would be refused if the recipient was covered under a private plan.

Provider Hierarchy 412

The provider hierarchy 412 can be a relatively simple two level hierarchy with the complication of special relationships that may be set up between provider 14 offices/providers and carriers/companies/departments 30. The two main business objects in the hierarchy are, such as but not limited to:

Provider Office and

Provider.

The special relationships are defined between provider offices or providers 14 and carriers 30 or companies or departments. These relationships are between the two different hierarchies 408,412 so there is not a ‘natural’ ordering. Because of this, the ordering of these relationships is defined on a case by case basis using the administrative screens of the module 42 (see FIG. 1). A suggested ordering is:

Carrier to Provider Office;

Carrier to Provider;

Company to Provider Office;

Company to Provider;

Department to Provider Office; and

Department to Provider.

The business purpose of the special relationships is that the carrier/company/department 30 agrees to direct recipients to the provider 14 office or provider in exchange for a reduced price.

An authorizing physician hierarchy of the hierarchy 412 provides for authorizing physicians who authorizes a specific treatment or benefit, with the usual case being a physician prescribing a drug that is then dispensed by a pharmacist. The authorizing physician hierarchy can be simple with only one level. There is a similar complication as above due to the potential special relationships between authorizing physician and carriers/companies/departments. The main business object 400 in the hierarchy is: Authorizing Physician. The special relationships are defined between authorizing physicians and carriers or companies or departments. These relationships are between two different hierarchies 408, 412 so there is not a ‘natural’ ordering. Because of this, the ordering of these relationships is defined on a case by case basis using the administrative screens. A suggested ordering is:

Carrier to Authorizing Physician;

Company to Authorizing Physician; and

Department to Authorizing Physician.

Note that this hierarchy 412 can be used for prescribers within pharmacy systems as well as dentists.

Benefit Hierarchy 410

Benefits are intimately tied to the claim type (drug, dental, vision, etc.). Based on the submitted claim type, benefits are validated against the benefit tables appropriate for that claim type. The structure of these claim transactions 12 is such that the benefit hierarchies 410 are defined in different manners for the different claim types. Note that, in general, a ‘benefit group’ can cross the lines of business (dental, drug, medical, vision, . . . ). Benefit groups resolve to a list of individual benefits that are included, based on the included and excluded groups. For performance reasons, it's expected that the hierarchy of inclusions and exclusions will be maintained in one table through the maintenance screens, and these tables will be de-normalized to a separate table that the adjudication engine 402 will actually query through the appropriate business objects 400.

A benefit is used generically to refer to a claimable item such as a dental procedure, or pharmacy prescription. A benefit is defined with many attributes such as benefit code, a label and line of business (dental/medical etc.). For example:

| Benefit Code | Line of Business | Label |
|---|---|---|
| 01101 | Dental | COMPLETE EXAM |
| | | PRIMARY |
| 01202 | Dental | RECALL EXAM |
| 00598194 | Drug | APO-PREDNISONE |
| 00598461 | Drug | PMS-SULFASALAZINE |
| 03.03AE | Medical (AB) | Diagnostic interview and . . . |
| 03.03AP | Medical (AB) | Home visit - second/subs . . . |

A Benefit is a re-usable business object 400; the benefit is defined only once, and this benefit could have a relationship with many blocks, which is an arbitrary grouping or category of benefits. For example, in dental, a procedure has 3 categories associated with it, Major Category, Category and Package. Each claimable item (benefit) belongs to a package. Each package belongs to a category, and each category belongs to a major category. Further, benefit groups do not expire. Once a benefit group is first set up and used in more than one place (including claim and fiscal experience business objects 400), that benefit group may not be changed without considering the impact on the claims experience records. Benefits can be added to the group, although claims experience records will not be updated automatically to include that group for the newly added benefit. Removing a benefit from a group also does not update any records for that benefit already existing in claims experience. If a change is required that affects claims experience, the benefit group will have to be cloned, given a different label, the appropriate changes made, and then the old benefit group link updated to point to the new benefit group link. The reason for not having effective/expiry dates for benefit groups is that their presentation to the maintainer through the maintenance screens is problematic and potentially very confusing (the effective/expiry dates from the plans, plan exceptions, and benefit groups may all be different).

Referring to FIG. 5, the following hierarchies 406 are coupled to or are otherwise subsets of the benefit hierarchy 410. Dental Benefits 500, such that the following categorizations of dental benefits of FIG. 5 are possible. A ‘benefit group’ can include and exclude based on these categories and values. Drug Benefits 502, such that the following categorizations of drug benefits of FIG. 5 are possible. A ‘benefit group’ can include and exclude based on these categories and values, such as but not limited to:

Federal schedule code;

Manufacturer code;

Generic indicator;

Maintenance indicator;

Therapeutic class (AHFS);

Drug category code (DCC);

Generic code number (GCN);

Route of administration;

GP indicator;

Provincial schedule code;

Provincial formulary code;

Provincial interchange code;

User defined categories; and

Drug identification number (DIN).

There is a loose hierarchy of:

Drug category code (DCC);

Therapeutic class (AHFS);

Specific therapeutic class (HIC3);

HICL sequence number;

Generic code number (GCN); and

Drug identification number (DIN).

Vision Benefits 504, such that the following categorizations of vision benefits of FIG. 5 are possible. A group of vision benefits can include and exclude based on these categories and values, such as but not limited to:

Type (frame, lenses, contacts, examinations);

Service (new product, professional fee for lesson, repair);

Prescription + or −; and

Code.

Medical Benefits 506, such that the following categorizations of medical benefits of FIG. 5 are possible. A group of medical benefits can include and exclude based on these categories and values, such as but not limited to:

Category;

Service;

CCP or CCI service code; and

ICD-9 or ICD-10 code (potentially).

Operation of the Adjudication System 100

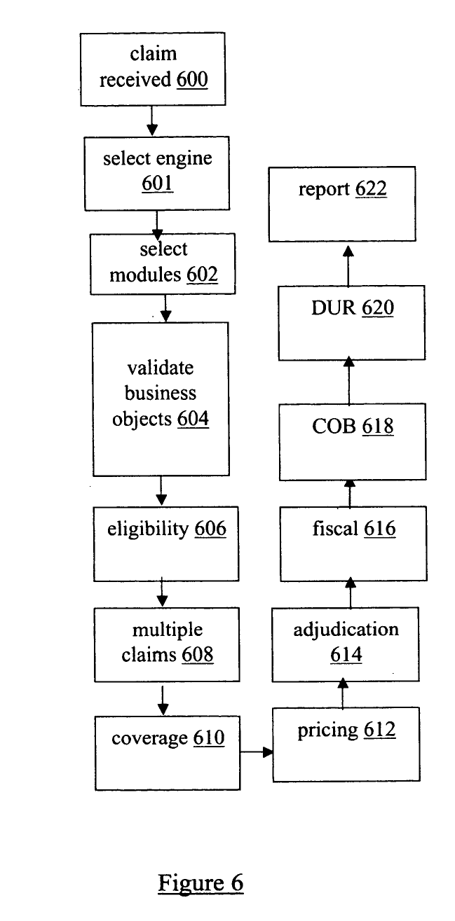

Referring to FIG. 6, at step 600 the claim transaction 12 is received and the appropriate adjudication engine 402 is selected 601 by an engine selector 107 of the adjudication system 100. The appropriate plan modules 404 are retrieved 602 from the various hierarchies 406 during the eligibility validation 604 of the business objects 400 and coalesced into the set of plan modules that will be processed, as applied against the data contents of the business objects 400 associated with the claim transaction 12. The precedence used when coalescing the plan modules 404 is configurable.

The adjudication process of the adjudication system 100 consists of the following further steps performed in sequence. After each step, the claim transaction 12 status can be checked to determine if the following modules 404 should be executed or if the adjudication process should stop. The following description applies to the Add claims, with Predetermination claims being closely related. Delete claims are relatively simple, while Reassess claims are simply a Delete and Add done in a single claim transaction 12. The Adjudication System 100 can be thought of as a factory class (i.e. the selector 107) that returns the appropriate adjudication engine 402 according to the characteristics of the received claim transaction 12. The adjudication system factory class takes a source identifier (a string) and an uninitialized claim object 400 with a valid raw claim (the ASCII string or the XML transaction). The factory returns the appropriate adjudication engine 402 for the source and claim version and type passed into the adjudication system 100.

As noted above, the Adjudication System 100 is an ordered collection of the Adjudication Modules 404. Each adjudication module 404 has a single purpose (ideally), only performs business logic operations (no state within the module 404), and can have two methods, for example: process(Claim claim) and process(Claim claim, ClaimItem claimItem). The Claim and ClaimItem instances are the data context of the business objects 400 associated with the claim transaction 12 within which the adjudication modules 404 operate. The abstract base class for the adjudication modules 404 can have logging, timing, and other base functionality built in to be used by the derived concrete classes. Since the adjudication modules 404 just contain logic, there is no need to pool the modules 404 for performance reasons. However, a factory method is used to simplify the class loader based module 404 replacement logic described next. Updating adjudication modules 404 in a running system 100 is allowed through the replacement of the classloader used in loading the current adjudication modules 404 used by the adjudication engine 402. Claim transactions 12 in progress keep using in-memory adjudication modules 404 they have already been assigned, but any new claim transactions 12 arriving to the adjudication system 100 (and are assigned their appropriate engine 402 by the selector 107) are assigned using the new classloader in the factory, resulting in using the new adjudication modules 404. Eventually, no references to the old classloader/adjudication modules 404 are left and it's garbage collected.

Note that in the below, although modules 404 are discussed as if a single module 404 implements an entire step in the adjudication process, in actuality there can be usually several different adjudication modules 404 configured to perform each step. For example, the eligibility step can have separate modules for validating providers, prescribers, procedures, subscribers, recipients, departments, although the eligibility step is discussed as a single module 404 for simplicity.

Eligibility is Checked at Step 606 by the Eligibility Module 404.

Eligibility answers the question ‘is each of the individual business objects 400 referred to in the claim item valid?’ This module 404 instantiates each of the business objects 400 using the information provided from the claim object. Each business object 400is responsible for collecting and collating (e.g. from the hierarchies 406) any plan information attached to itself. This involves retrieving the plan information from the database 102, ordering and coalescing the plan information appropriately. This module 404 is processed once for each claim transaction 12, regardless of the number of claim items. Because of this, the benefit eligibility is deferred to the next Coverage module 404.

Multiple Claim Items Step 608

For those claim types that have multiple claim items per submitted claim transaction 12, such as CDA4, each claim item will be adjudicated in turn. Operations that do not change with the claim item, such as eligibility checks by the eligibility module 404 for all but the benefit related information, are only performed once. Then the per claim item operations are performed. Finally, the individual claim item results are gathered together and the response is formatted appropriately for the entire claim transaction 12.

Some errors, such as simple edit check errors, only affect the current claim item being processed and allow the other claim items (if any) to continue being processed. Other errors stop the processing for the complete claim transaction 12. Each claim item should be examined to determine if it's a duplicate of a claim item that is already in claims experience business objects 400 (or in the held state within claims experience). There are two stages to this test, first look for the same claim identifier, then look for the same service event by the same provider 14 in the same location on the same day for the same recipient. The first check, for the duplicate claim identifier, is a simple check that does not need to be explained. The second check is such that the following information can be assumed to be proper, meaning that if these fields don't match the claim's service event is considered to be different:

Provider;

Location;

Subscriber;

Service date;

Benefit; and

Multiple service indicator (I.E. calls).

That leaves identifying the recipient. Because there is not a standard unique number for identifying people in Canada (unlike the SSN in USA, Canada does not allow the SIN to be used for this), it is problematic to identify the recipient consistently and uniquely. This leaves the ‘tombstone’ data as the method to identify the recipient, such as:

Recipient code and exception code on the arriving claim transaction 12;

Recipient's last name;

Recipient's first name or initial;

Recipient's middle name or initial;

Recipient's birth date; and

Recipient's gender.

Once the recipient has been matched successfully as described below, that unique recipient identifier is used to determine if this is a duplicate service event. If a duplicate service event is found within claims experience business objects 400, the claim transaction 12 is refused with the proper EOB.

Examples of Eligibility Checking

To allow flexibility we can use a matching algorithm by the eligibility module 404 at the carrier level that sets weights for each of the criteria used in matching the recipient. If the sum of the criteria weight for the matching criteria passes a threshold, the recipient is matched. If more than one recipient passes the threshold, the highest sum wins. If more than one record has the highest sum, the claim is pended for manual processing. This allows the weighting criteria to be adjusted for this subscriber, or for the bad data to be cleaned up. For example, the criteria and weighting shown would result in a total score of 80. If this score is below the minimum threshold, then the recipient is not matched and the claim is refused. If another recipient associated with this subscriber has a higher score, that recipient would be matched instead. By setting the weight on a certain criteria very high (such as the recipient code), that criteria can be required to declare a recipient match.

| | | Claim | Database | |
|---|---|---|---|---|
| Criteria | eight | Value | Value | Score |
| Recipient code | 0 | Spouse | Spouse | 50 |
| Recipient last name | 0 | Smith | Smithe | 0 |
| Recipient first | 0 | Rob | Rod | 10 |
| initial | | | | |
| YYMM of recipient | 0 | 1934/02/13 | 1934/02/15 | 0 |
| birthdate | | | | |
| Recipient gender | 0 | F | F | 20 |
| Total Score | | | | 80 |

To allow for the proverbial twins with the same first name and middle initial, the weighting scheme can be modified at the subscriber level of the hierarchies 406, thus affecting the manipulation of the related business objects 400.

It is noted that the matching criteria here has to be the same criteria used to find claim transactions 12 to reassess or delete. This is so that the following situation does not arrive:

Provider 14 sends in claim A and gets paid less than what he wanted;

Provider 14 sends in reassess request on claim A but with enough information different to not match;

The reassess is refused since the original claim can't be found;

Provider 14 tries to delete claim A but enough information is different to not match;

The delete is refused since the original claim can't be found;

Provider 14 tries to add claim A (since delete says its not there) but the claim identifier is found; and

The add is refused since the original claim transaction 12 still exists.

The provider 14 has his computer telling him he can't delete/reassess the claim since it can't be found. But the computer also says he can't add the claim transaction 12 again since it already exists. This can result in a frustrated provider, and a phone call to the carrier/insurer.

Currently, out of order claims experience records (an experienced claim transaction 12 within active claims experience that is dated in the future compared to the claim transaction 12 being adjudicated) are identified and saved within a table. The adjudication system 100 uses a batch job to sort and process these out of order claim transactions 12 periodically (expected to run nightly) and add the appropriate adjustments to the payment information sent to the payment system 28. Unsolicited responses are also generated if significant changes are encountered. These are retrievable through the online reporting system 106 as well.

The adjudication rules can also mark experienced claim transactions 12 for reassessment, for example an adjudication rule may require a initial consult and referral for a given service. The referral claim transaction 12 may arrive first and be refused initially, and then later marked for reassessment when the initial consult claim transaction 12 is submitted. The reassessment of the referral claim transaction 12 then pays the appropriate amount.

Edit check answers the question ‘is the information provided in the claim well-formed, consistent, and enough to adequately define a claim object and associated business objects 400. These lightweight checks are performed without accessing the database 102 and merely ensure the various fields are properly formed. Examples are that numeric fields are numeric, service dates are not future dated, dates are valid dates, subscriber numbers have a valid checksum (if configured), etc. Validation of the fields against the database 102 (for subscriber id as an example) is done in a lazy manner within each of the business objects 400. These checks are performed within the claim deserialization process, which converts an arriving ASCII string of characters into a skeleton claim object 400 full of identifiers and other information from the arriving claim transaction 12. The claim object 400 serves as the context or repository of data about the claim transaction 12 currently being adjudicated, as well as serving as the entry point for accessing all other business objects 400, such as provider, recipient, claims experience, etc. The claim object 400 has the method to check for duplicates based on claim identifier. The claim item object 400 has the method to check for duplicates based on the service performed. The claim object 400 is specialized for each line of business, and potentially for claim formats and versions within a single line of business as well. It is simple to add extra attributes used by the rule processing logic of the modules 404 (e.g. add an attribute indicating that this claim transaction 12 has been approved by a special authorization based on the provider 14 and the service which the adjudication rules use later).

The next steps of the operation are performed in accordance with the relevant engine 402 as per the descriptions of the related modules 404 above, for example coverage at step 610, pricing at step 612, application of adjudication rules at step 614, application of fiscal rules at step 616, application of COB rules at step 618, and application of DUR rules at step 620. Once the claim transaction 12 processing is complete, either by a successful application of all modules 404 and associated functions/methods/actions (e.g. rules) to the business objects 400, or not, the claim transaction 12 is reported 622 to the database 12 (and subsequently to the provider 14 and/or payer 30 as needed) either as rejected or accepted or pending, as described above.

Appendix A - Adjudication Engine Configuration

adj_module.list = DentalProviderEligibility, DentalProviderOfficeEligibility, DentalSubscriberEligibility, \

DentalCompanyEligibility, DentalDepartmentEligibility, DentalCarrierEligibility,

DentalRecipientEligibility, \

CheckDuplicateProviderSeq CheckDuplicateServiceDate ValidateProcedure \
DentalOutstandingTransaction \
DentalProcedurePricing, DentalCoverage, SimpleAdjRules, SimpleCopay, COBPricing,

ManualOverride
; ------- provider eligibility -------
DentalProviderEligibility.class = adj.modules.impl.dental.eligibility.ProviderEligibility
DentalProviderEligibility.class.params = java.lang.Long
DentalProviderEligibility.class.args = 2
DentalProviderEligibility.copyFields.src = provider_id provider_vers billing_number last_name first_name
DentalProviderEligibility.copyFields.dst.provider_id = provider_id
DentalProviderEligibility.copyFields.dst.provider_vers = provider_vers
DentalProviderEligibility.copyFields.dst.last_name = last_name
DentalProviderEligibility.copyFields.dst.first_name = first_name
DentalProviderEligibility.copyFields.dst.billing_number = billing_number
; ------- provider office eligibility -------
DentalProviderOfficeEligibility.class = adj.modules.impl.dental.eligibility.ProviderOfficeEligibility
DentalProviderOfficeEligibility.class.params =
DentalProviderOfficeEligibility.class.args =
DentalProviderOfficeEligibility.copyFields.src = office_id office_vers office_id_num billing_id_num
DentalProviderOfficeEligibility.copyFields.dst.office_id = office_id
DentalProviderOrficeEligibility.copyFields.dst.office_vers = office_vers
DentalProviderOfficeEligibility.copyFields.dst.office_id_num = office_id_num
DentalProviderOfficeEligibility.copyFields.dst.billing_id_num = billing_id_num
; ------- carrier eligibility -------
DentalCarrierEligibility.class = adj.modules.impl.dental.eligibility.CarrierEligibility
DentalCarrierEligibility.class.params =
DentalCarrierEligibility.class.args =
DentalCarrierEligibility.copyFields.src = carrier_id carrier_vers carrier_label adj_coverage_plan_id
adj_fiscal_plan_id adj_rule_plan_id adj_exception_plan_id
DentalCarrierEligibility.copyFields.dst.carrier_id = carrier_id
DentalCarrierEligibility.copyFields.dst.carrier_vers = carrier_vers
DentalCarrierEligibility.copyFields.dst.carrier_label = carrier_label
DentalCarrierEligibility.copyFields.dst.adj_coverage_plan_id = adj_coverage_plan_id
DentalCarrierEligibility.copyFields.dst.adj_fiscal_plan_id = adj_fiscal_plan_id
DentalCarrierEligibility.copyFields.dst.adj_rule_plan_id = adj_rule_plan_id
DentalCarrierEligibility.copyFields.dst.adj_exception_plan_id = adj_exception_plan_id
; ------- company eligibility -------
DentalCompanyEligibility.class = adj.modules.impl.dental.eligibility.CompanyEligibility
DentalCompanyEligibility.class.params =
DentalCompanyEligibility.class.args =
DentalCompanyEligibility.copyFields.src = company_id company_vers company_label
adj_coverage_plan_id adj_fiscal_plan_id adj_rule_plan_id adj_exception_plan_id
DentalCompanyEligibility.copyFields.dst.company_id = company_id
DentalCompanyEligibility.copyFields.dst.company_vers = company_vers
DentalCompanyEligibility.copyFields.dst.company_label = company_label
DentalCompanyEligibility.copyFields.dst.adj_coverage_plan_id = adj_coverage_plan_id
DentalCompanyEligibility.copyFields.dst.adj_fiscal_plan_id = adj_fiscal_plan_id
DentalCompanyEligibility.copyFields.dst.adj_rule_plan_id = adj_rule_plan_id
DentalCompanyEligibility.copyFields.dst.adj_exception_plan_id = adj_exception_plan_id
; ------- department eligibility -------
DentalDepartmentEligibility.class = adj.modules.impl.dental.eligibility.DepartmentEligibility
DentalDepartmentEligibility.class.params =
DentalDepartmentEligibility.class.args =
DentalDepartmentEligibility.copyFields.src = department_id department_vers department_label
adj_coverage_plan_id adj_fiscal_plan_id adj_rule_plan_id adj_exception_plan_id department_id_num
DentalDepartmentEligibility.copyFields.dst.department_id = department_id
DentalDepartmentEligibility.copyFields.dst.department_vers = department_vers
DentalDepartmentEligibility.copyFields.dst.department_label = department_label
DentalDepartmentEligibility.copyFields.dst.department_id_num = department_id_num
DentalDepartmentEligibility.copyFields.dst.adj_coverage_plan_id = adj_coverage_plan_id
DentalDepartmentEligibility.copyFields.dst.adj_fiscal_plan_id = adj_fiscal_plan_id
DentalDepartmentEligibility.copyFields.dst.adj_rule_plan_id = adj_rule_plan_id
DentalDepartmentEligibility.copyFields.dst.adj_exception_plan_id = adj_exception_plan_id
; ------- subscriber eligibility -------
DentalSubscriberEligibility.class = adj.modules.impl.dental.eligibility.SubscriberEligibility
DentalSubscriberEligibility.class.params =
DentalSubscriberEligibility.class.args =
DentalSubscriberEligibility.copyFields.src = subscriber_id subscriber_vers adj_coverage_plan_id
adj_fiscal_plan_id adj_rule_plan_id adj_exception_plan_id department_id
DentalSubscriberEligibility.copyFields.dst.subscriber_id = subscriber_id
DentalSubscriberEligibility.copyFields.dst.subscriber_vers = subscriber_vers
DentalSubscriberEligibility.copyFields.dst.department_id = department_id
DentalSubscriberEligibility.copyFields.dst.adj_coverage_plan_id = adj_coverage_plan_id
DentalSubscriberEligibility.copyFields.dst.adj_fiscal_plan_id = adj_fiscal_plan_id
DentalSubscriberEligibility.copyFields.dst.adj_rule_plan_id = adj_rule_plan_id
DentalSubscriberEligibility.copyFields.dst.adj_exception_plan_id = adj_exception_plan_id
; ------- recipient eligibility -------
DentalRecipientEligibility.class = adj.modules.impl.dental.eligibility.RecipientEligibility
DentalRecipientEligibility.class.params = java.lang.Integer java.lang.Integer java.lang.Integer
java.lang.Integer java.lang.Integer java.lang.Integer java.lang.Integer java.lang.Integer java.lang.Integer
DentalRecipientEligibility.class.args = 5 2 3 1 3 2 1 1 1
DentalRecipientEligibility.copyFields.src = recipient_id recipient_vers cob_flag adj_coverage_plan_id
adj_fiscal_plan_id adj_rule_plan_id adj_exception_plan_id
DentalRecipientEligibility.copyFields.dst.recipient_id = recipient_id
DentalRecipientEligibility.copyFields.dst.recipient_vers = recipient_vers
DentalRecipientEligibility.copyFields.dst.cob_flag = cob_flag
DentalRecipientEligibility.copyFields.dst.adj_coverage_plan_id = adj_coverage_plan_id
DentalRecipientEligibility.copyFields.dst.adj_fiscal_plan_id = adj_fiscal_plan_id
DentalRecipientEligibility.copyFields.dst.adj_rule_plan_id = adj_rule_plan_id
DentalRecipientEligibility.copyFields.dst.adj_exception_plan_id = adj_exception_plan_id
; ------- dental pricing -------
DentalProcedurePricing.class = adj.modules.impl.dental.pricing.ProcedurePricing
DentalProcedurePricing.class.params =
DentalProcedurePricing.class.args =
; ------- dental coverage -------
DentalCoverage.class = adj.modules.impl.dental.coverage.DentalCoverage
DentalCoverage.class.params =
DentalCoverage.class.args =
; ------- Fiscal rules -------
SimpleCopay.class = adj.modules.impl.dental.fiscal.simpleCopay
SimpleCopay.class.params = java.lang.Double
SimpleCopay.class.args = 0.80
; ------- Adj rules -------
SimpleAdjRules.class = adj.modules.impl.dental.adjrules.SimpleAdjRules
SimpleAdjRules.class.params = java.lang.Boolean java.lang.String
SimpleAdjRules.class.args = true adj.db
; ------- COB -------
COBPricing.class = adj.modules.impl.COBPricing
COBPricing.class.params =
COBPricing.class.args =
; ------- ManualOverride -------
ManualOverride.class = adj.modules.impl.dental.manualoverride.ManualOverride
ManualOverride.class.params =
ManualOverride.class.args =
; ------- CheckDuplicateProviderSeq -------
CheckDuplicateProviderSeq.class = adj.modules.impl.dental.CheckDuplicateProviderSeq
; param1, module active - false to ignore this module
CheckDuplicateProviderSeq.class.params = java.lang.Boolean
CheckDuplicateProviderSeq.class.args = false
; ## warning, this module is currently turned off
; ------- CheckDuplicateServiceDate -------
CheckDuplicateServiceDate.class = adj.modules.impl.dental.CheckDuplicateServiceDate
; param1, module active - false to ignore this module
CheckDuplicateServiceDate.class.params = java.lang.Boolean
CheckDuplicateServiceDate.class.args = false
; ## warning, this module is currently turned off
; ------- ValidateProcedure -------
ValidateProcedure.class = adj.modules.impl.dental.ValidateProcedure
ValidateProcedure.class.params =
ValidateProcedure.class.args =
; ------- DentalOutstandingTransaction -------
DentalOutstandingTransaction.class =
adj.modules.impl.dental.outstandingresp.SetOutstandingTransactionFlag
DentalOutstandingTransaction.class.params =
DentalOutstandingTransaction.class.args =

APPENDIX B
Example claim line items
Claim Line Item Record Layout

| | | Field | Field | Starting |
|---|---|---|---|---|
| Field Definition | Field Name | Type | Length | Location |
| Provider Number | PROVIDRNO | A | 7 | 1 |
| Contract Number | CONTRACTNO | A | 7 | 8 |
| Provider Zip Code | PROVZIP | A | 9 | 15 |
| Provider Specialty | SPECIALITY | A | 4 | 24 |
| Provider Type | PROVTYPE | A | 4 | 28 |
| Provider Name | PROVGRPNAM | A | 50 | 32 |
| Tax ID Number | TIN | A | 9 | 82 |
| TIN Suffix | TINSUFFIX | A | 2 | 91 |
| Claim Reference | CLAIMREFNO | A | 12 | 93 |
| Number | | | | |
| Policy Number | POLICY | A | 10 | 105 |
| Claimant Number | CLAIMANTNO | A | 2 | 115 |
| Form ID | FORMID | A | 25 | 117 |
| Service Line ID | SVCLINEID | A | 25 | 142 |
| Document ID | DOCUMENTID | A | 10 | 167 |
| Network | NETWORK | A | 6 | 177 |
| Form Type | FORMTYPE | A | 1 | 183 |
| Claimant Name | CLAIMANTNM | A | 30 | 184 |
| Claimant Date of | CLAIMNTDOB | A | 8 | 214 |
| Birth | | | | |
| Patient Account | PATACCTNO | A | 17 | 222 |
| Number | | | | |
| Patient Sex | PATSEX | A | 1 | 239 |
| Bill Type | BILLTYPE | A | 3 | 240 |
| Hospital Admission | ADMITDATE | A | 8 | 243 |
| Date | | | | |
| From Date | FROMDATE | A | 8 | 251 |
| Thru Date | THRUDATE | A | 8 | 259 |
| Relationship Number | RELATNO | A | 1 | 267 |
| Accident Flag | ACCIDNTFLG | A | 1 | 268 |
| Diagnostic Related | DRG | A | 5 | 269 |
| grouping | | | | |
| Discharge Status | DISCHGSTAT | A | 2 | 274 |
| Admitting Diagnosis | ADMITDIAG | A | 8 | 276 |
| Condition Code 1 | CONDCODE1 | A | 2 | 284 |
| Condition Code 2 | CONDCODE2 | A | 2 | 286 |
| Condition Code 3 | CONDCODE3 | A | 2 | 288 |
| Condition Code 4 | CONDCODE4 | A | 2 | 290 |
| Condition Code 5 | CONDCODE5 | A | 2 | 292 |
| Diagnosis 1 | DIAGNOSIS1 | A | 6 | 294 |
| Diagnosis 2 | DIAGNOSIS2 | A | 6 | 300 |
| Diagnosis 3 | DIAGNOSIS3 | A | 6 | 306 |
| Diagnosis 4 | DIAGNOSIS4 | A | 6 | 312 |
| Diagnosis 5 | DIAGNOSIS5 | A | 6 | 318 |
| Diagnosis Pointer | DIAGPTR | A | 1 | 324 |
| Occurrence Code 1 | OCCURCODE1 | A | 2 | 325 |
| Occurrence Code 2 | OCCURCODE2 | A | 2 | 327 |
| Occurrence Code 3 | OCCURCODE3 | A | 2 | 329 |
| Occurrence Code 4 | OCCURCODE4 | A | 2 | 331 |
| Occurrence Date 1 | OCCCDEDAT1 | A | 8 | 333 |
| Occurrence Date 2 | OCCCDEDAT2 | A | 8 | 341 |
| Occurrence Date 3 | OCCCDEDAT3 | A | 8 | 349 |
| Occurrence Date 4 | OCCCDEDAT4 | A | 8 | 357 |
| Hospital Procedure1 | HOSPPROC1 | A | 5 | 365 |
| Hospital Procedure2 | HOSPPROC2 | A | 5 | 370 |
| Hospital Procedure3 | HOSPPROC3 | A | 5 | 375 |
| Hospital Procedure4 | HOSPPROC4 | A | 5 | 380 |
| Procedure Modifier | PROCMOD | A | 2 | 385 |
| Amount Billed | AMTBILLED | A | 10 | 387 |
| Place of Service | CDPOS | A | 3 | 397 |
| Type of Service | CDTOS | A | 1 | 400 |
| Number of Units/Days | NOUNITS | A | 3 | 401 |
| Revenue Code | REVCODE | A | 3 | 404 |
| Contract Rate Amount | AMTCONRATE | A | 10 | 407 |
| Date Filed | FILEDATE | A | 8 | 417 |
| Time Filed | FILETIME | A | 4 | 425 |
| Line Number | LINENUMB | A | 3 | 429 |
| File Name | FILENAME | A | 8 | 432 |
| Office ID | OFFICEID | A | 1 | 440 |
| Line Sequence Number | LINESEQNO | A | 4 | 441 |

The embodiments of the invention in which an exclusive property or privilege is claimed are defined as follows:

1. A method for configuring an adjudication system to adjudicate a claim transaction, the method comprising the steps of:
receiving the claim transaction containing at least one line item describing an insured service for a recipient to be financed by a payer for the insured service;
providing an adjudication engine for coordinating the adjudication processing of the received claim transaction;
representing the claim transaction as a plurality of data containers coupled to a database such that the data containers are selected from a set of available data containers, the data containers coupled to the adjudication engine and configured for containing data instances of the claim transaction; and
selecting a plurality of adjudication modules for coupling to the plurality of data containers, the plurality of adjudication modules selected from a set of available adjudication modules, the selected adjudication modules configured for providing business logic for application to the data containers during the adjudication processing to manipulate the data instances of the data containers;
wherein the configured adjudication system adjudicates the data instances of the data containers according to the business logic of the selected adjudication modules for determining an adjudication status of the claim transaction.

2. The method according to claim 1 further comprising the step of selecting the data containers from a set of available data containers.

3. The method according to claim 2, wherein the selection of the data containers is coordinated by the modules.

4. The method according to claim 2, wherein the data containers are represented as business objects associated with the database.

5. The method according to claim 4, wherein the business objects are selected from the group comprising: claim; claim item; claim experience; fiscal experience; drug experience; plan; benefit; provider; and recipient.

6. The method according to claim 5, wherein the experience business objects are configured to contain historical information associated with the claim transaction.

7. The method according to claim 4 further comprising the step of the business objects collecting plan information from a hierarchy including inheritance characteristics of the business objects, the plan information related to the insured service associated with the claim transaction.

8. The method according to claim 4 further comprising the step of coupling the business objects to at least one hierarchy including inheritance characteristics of the business objects, the at least one hierarchy for describing a plan related to the insured service.

9. The method according to claim 8, wherein the at least one hierarchy provides for an override of attributes of the business objects.

10. The method according to claim 8 further comprising the step of selecting the hierarchies from the group comprising: carrier; benefit providing the benefits associated with the insured service; and provider providing the insured services.

11. The method according to claim 4 further comprising the step of receiving a plurality of claim transactions for representing as the plurality of data containers, the plurality of claim transactions processed by the adjudication engine in parallel.

12. The method according to claim 4 further comprising the step of reusing selected data containers for a subsequent claim transaction processed after the claim transaction.

13. The method according to claim 1 further comprising the step of selecting the adjudication engine from a set of available adjudication engines based on at least one engine selection criterion, the at least one engine criterion associated with claim characteristics of the received claim transaction.

14. The method according to claim 13, wherein the adjudication engine contains definitions of the modules and the business objects to be applied based on the characteristics of the received claim transaction.

15. The method according to claim 13 further comprising the step of the adjudication engine coordinating the selection of the modules.

16. The method according to claim 15 further comprising the step of the adjudication engine coordinating the application of the business logic of the modules to the data instances of the data containers.

17. The method according to claim 13, wherein the adjudication engine is determined based on a line of business selected from the group comprising: medical; dental; vision; flexible benefits; and drug.

18. The method according to claim 17, wherein the claim transaction contains line items pertaining to at least two lines of business.

19. The method according to claim 1 further comprising the step of the modules applying the business logic to the data instances of the data containers in order to determine the state of the data containers.

20. The method according to claim 3, wherein the modules instantiate the data containers according to a claim data container representing the characteristics of the claim transaction.

21. A system for configuring an adjudication system to adjudicate a claim transaction, the system comprising:
an adjudication system for receiving the claim transaction containing at least one line item describing an insured service for a recipient to be financed by a payer for the insured service;
an adjudication engine of the adjudication system for coordinating the adjudication processing of the received claim transaction;
a plurality of data containers coupled to a database for representing the claim transaction such that the data containers are selectable from a set of available data containers, the data containers coupled to the adjudication engine and configured for containing data instances of the claim transaction; and
a plurality of adjudication modules for coupling to the plurality of data containers, the plurality of adjudication modules selectable from a set of available adjudication modules, the adjudication modules configured for providing business logic for application to the data containers during the adjudication processing to manipulate the data instances of the data containers;
wherein the configured adjudication system adjudicates the data instances of the data containers according to the business logic of the selected adjudication modules for determining an adjudication status of the claim transaction.

22. The system according to claim 21, wherein the data containers are selectable from a set of available data containers.

23. The system according to claim 22, wherein the selection of the data containers is coordinated by the modules.

24. The system according to claim 22, wherein the data containers are represented as business objects associated with the database.

25. The system according to claim 24, wherein the business objects are selected from the group comprising: claim; claim item; claim experience; fiscal experience; drug experience; plan; benefit; provider; and recipient.

26. The system according to claim 25, wherein the experience business objects are configured to contain historical information associated with the claim transaction.

27. The system according to claim 24, wherein the business objects are configured to collect plan information from a hierarchy including inheritance characteristics of the business objects, the plan information related to the insured service associated with the claim transaction.

28. The system according to claim 24 further comprising at least one hierarchy including inheritance characteristics of the business objects, the at least one hierarchy for describing a plan related to the insured service, the business objects coupled to the hierarchy.

29. The system according to claim 28, wherein the at least one hierarchy provides for an override of attributes of the business objects.

30. The system according to claim 28, wherein the hierarchies are selected from the group comprising: carrier; benefit providing the benefits associated with the insured service; and provider providing the insured services.

31. The system according to claim 24, wherein the adjudication system is configured to receive a plurality of claim transactions are for representing as the plurality of data containers, the plurality of claim transactions processed by the adjudication engine in parallel.

32. The system according to claim 24, wherein the selected data containers are reusable for a subsequent claim transaction processed after the claim transaction.

33. The system according to claim 21 further comprising the adjudication system configured for selection of the adjudication engine from a set of available adjudication engines based on at least one engine selection criterion, the at least one engine criterion associated with claim characteristics of the received claim transaction.

34. The system according to claim 33, wherein the adjudication engine contains definitions of the modules and the business objects to be applied based on the characteristics of the received claim transaction.

35. The system according to claim 33, wherein the adjudication engine is configured to coordinate the selection of the modules.

36. The system according to claim 35, wherein the adjudication engine is configured to coordinate the application of the business logic of the modules to the data instances of the data containers.

37. The system according to claim 33, wherein the adjudication engine is determined based on a line of business selected from the group comprising: medical; dental; vision; flexible benefits; and drug.

38. The system according to claim 37, wherein the claim transaction contains line items pertaining to at least two lines of business.

39. The system according to claim 21, wherein the modules are configured to apply the business logic to the data instances of the data containers in order to determine the state of the data containers.

40. The system according to claim 23, wherein the modules instantiate the data containers according to a claim data container representing the characteristics of the claim transaction.

41. A computer program product for configuring an adjudication system to adjudicate a claim transaction, the computer program product comprising:
a computer readable medium;
an adjudication system module stored on the computer readable medium for receiving the claim transaction containing at least one line item describing an insured service for a recipient to be financed by a payer for the insured service;
an adjudication engine module coupled to the adjudication system module for coordinating the adjudication processing of the received claim transaction;
a data container module coupled to the adjudication system module for providing a plurality of data containers coupled to a database for representing the claim transaction such that the data containers are selectable from a set of available data containers, the data containers coupled to the adjudication engine module and configured for containing data instances of the claim transaction; and
a plurality of adjudication modules for coupling to the plurality of data containers, the plurality of adjudication modules selectable from a set of available adjudication modules, the adjudication modules configured for providing business logic for application to the data containers during the adjudication processing to manipulate the data instances of the data containers;
wherein the configured adjudication system module adjudicates the data instances of the data containers according to the business logic of the selected adjudication modules for determining an adjudication status of the claim transaction.
